(19) United States
(12) Patent Application Publication
(10) Pub. No.: US 2004/0191489 A1
(43) Pub. Date: Sep. 30, 2004

(54) Packaging material

(76) Inventors: Shigeru Minato, Kanagawa (JP); Norihide Endou, Tokyo (JP)

Correspondence Address: MS. YUMI YERKS, 2111 JEFFERSON DAVIS HIGHWAY, APARTMENT #412, NORTH, ARLINGTON, VA, 22202, US

(21) Appl. No.: 10/786,075

(22) Filed: Feb. 26, 2004

(30) Foreign Application Priority Data
Feb. 28, 2003 (JP) 2003-53858

(51) Int. Cl. B32B 3/00

(52) U.S. Cl. 428/204

(57) ABSTRACT

The present invention provides a packaging material which comprises: base material paper; a printed layer formed on the base material paper by an ultraviolet curable ink; and an overprint varnish layer which covers substantially the entire surface of the base material paper with the printed layer formed thereon, wherein a coefficient of dynamic friction on a surface of the overprint varnish layer, which is measured in a friction coefficient test based on JIS P8147 in a state in which the surfaces of the overprint varnish layers overlap and contact with each other under a load of 3000 g for each area of 63.5 mm×63.5 mm, is in a range of 0.300 to 0.600, and a coefficient of static friction measured in the same condition ranges from 0.600 to 0.900. According to the present invention, a packaging material having excellent wear resistance and scratching resistance is provided.

### CROSS-REFERENCE TO RELATED APPLICATION

This application claims priority under 35 USC 119 from Japanese Patent Application No. 2003-053858, the disclosure of which is incorporated by reference herein.

### BACKGROUND OF THE INVENTION

1. Field of the Invention

The present invention relates to a packaging material. Specifically, the present invention relates to a packaging material such as a carton which is printed with an ultraviolet curable ink, which packaging material has moderately stable slipping properties on the surface thereof and allows improvement in mechanical properties such as feeding properties in a packaging machine.

2. Description of the Related Art

Conventionally, a packaging material such as a carton is subjected to color printing of images or characters using printing means, principally by planographic printing (offset printing), gravure printing, or flexographic printing. A transparent overprint varnish (hereinafter referred to as “OP varnish”) layer is provided on an underlying printed layer by printing or coating means for the purposes of protecting the underlying printed layer, improving frictional resistance or scratching resistance, providing moderate slipping properties, and further providing gloss to improve the design character of a packaging material.

In planographic printing, in particular, an ultraviolet curable ink, which can be instantaneously dried and effects formation of an ink film having excellent strength, has been used in recent years as a printing ink in addition to a conventional oil based ink. In the past, the ultraviolet curable ink was expensive, and therefore, the use of the ink was restricted, in spite of its excellent performance. However, the use of the ultraviolet curable ink is now increasingly common.

In a packaging material such as a carton which is printed with an ultraviolet curable ink for planographic printing, an OP varnish is generally provided by printing on an entire surface of a printed layer which includes images and the like, except for a portion for adhesive-bonding, to further improve frictional resistance or scratching resistance and provide moderate slipping properties and gloss.

When the ultraviolet curable ink is used to print images and the like, ultraviolet curable OP varnish is generally used so that the OP varnish is printed in line with the printing of images and the like.

The above-described ultraviolet curable OP varnish for planographic printing is required to have the property of being hardened due to ultraviolet irradiation, and rheology suited for planographic printing, as is the case with the ultraviolet curable ink for planographic printing. For this reason, the ultraviolet curable OP varnish may include, as the principal component, a resin composition similar to a vehicle used for the ultraviolet curable ink. In addition, a slipping agent, for example, waxes such as a low-molecular-weight polyethylene wax or a macromolecular wax, or various types of silicone compounds such as silicone oil or silicone resin, which slipping agent improves the surface slipping properties to thereby improve frictional resistance or scratching resistance, and further, additives such as a photo-polymerization initiator, a sensitizer, a polymerization inhibitor, and an extender may be appropriately added for use.

Further, as the “ultraviolet curable overprint varnish composition” which can be used in planographic printing, an ultraviolet curable overprint varnish composition has been disclosed, for example, in Japanese Patent Application Laid-Open (JP-A) No. 10-17787, which composition contains: a reactive resin (A) obtained by continuously polymerizing 30% by weight of at least one type of (meth)acrylate having one or more hydroxyl groups and 70% or less by weight of at least one type of monomer having one ethylenic unsaturated group other than the above-described (meth)acrylate at a copolymerization temperature in the range of 150 to 350° C. to thereby obtain a copolymer (a) having a number average molecular weight of 1000 to 10000, and subsequently, by effecting an esterification reaction between a monomer having one or more ethylenic unsaturated group and one carboxyl group, and a hydroxyl group of the above-described copolymer (a); a reactive diluent (B) composed of at least one kind of ultraviolet curable monomer; and a photo-initiator (C).

In addition to the above-described essential components, the above composition may also include, if necessary, an inorganic filler such as barium sulfate, silicon dioxide, talc, clay or calcium carbonate, a dye or pigment such as phthalocyanine blue, phthalocyanine green, titanium oxide or carbon black, various additives such as viscosity modifier, processing agent, ultraviolet blocking agent, adhesion imparting agent and levelling agent, and a polymerization inhibitor such as hydroquinone.

Further, for example, Japanese Patent Application Laid-Open (JP-A) No. 2000-327709 discloses, as an “energy beam curable, water-based resin composition and overprint varnish” which can also be used in planographic printing, an energy beam curable, water-based resin composition including: (A) a water-soluble resin having one or more ethylenic unsaturated group in a molecule; (B) a tertiary amine compound; and (C) a polymer dissoluble in alcohol and water, and overprint varnish composed of this resin composition.

The above-described energy beam-curable, water-based resin composition may contain, if necessary, water added for the purpose of viscosity adjustment or the like, and may also contain known additives such as a plasticizer, a stabilizer, wax, lubricant, a dispersing agent, filler, an antifoaming agent, an ultraviolet absorber, an antioxidant, a polymerization inhibitor, an antistatic agent and fluorescent dye.

In cases in which packaging materials such as folding cartons, in which the above-described ultraviolet curable OP varnish composition for planographic printing has been printed on a printed layer of images and the like, are used by an ordinary packaging machine of which operating speed at the time of packaging is set at a speed of 100 to 200 cartons/minute, there arises no significant problem. However, in cases in which these packaging materials are used by a high-speed packaging machine of which operating speed at the time of packaging is set at a speed of 500 to 800 cartons/minute, a large quantity of empty cartons stacked in a carton supplying section needs to be pulled out one by one from the lower side, and each of cartons to be pulled out is subjected to a load of approximately 3 to 5 kg. For this reason, when the cartons are each pulled out, the slipping properties of a carton surface, particularly, the coefficient of dynamic friction becomes unstable. As a result, there arises a problem in that simultaneous feeding of two cartons in a supplying section, or a phenomenon in which a carton jumps out from a carton box-making section occurs, thereby degrading the performance of a packaging machine.

### SUMMARY OF THE INVENTION

Accordingly, in view of the above-described circumstances, the present invention provides a packaging material in which a printed layer of images or the like is formed on base material paper such as a carton by an ultraviolet curable ink, and an overprint varnish layer comprised of an ultraviolet curable OP varnish composition is formed on the printed layer, which packaging material has excellent wear resistance and scratching resistance, and even if the packaging material is fed out at a high speed, with a relatively high load applied thereto, in a packaging machine having a high operating speed at the time of packaging, for example, a speed of 500 to 800 cartons/minute, not to mention an ordinary packaging machine whose operating speed at the time of packaging is, for example, 100 to 200 cartons/minute, excellent slipping properties between surfaces of overlapped packaging material is exhibited, and the packaging material also has excellent surface physical properties and excellent packaging performance without causing simultaneous feeding of two cartons in a carton supplying section, or a phenomenon in which a carton jumps out from a carton box-making section.

In order to solve the above-described object, the present inventors have diligently studied a packaging material in which a printed layer is formed on base material paper such as a carton by an ultraviolet curable ink, and an overprint varnish layer composed of an ultraviolet curable OP varnish composition is formed on the printed layer. The present inventors have paid keen attention to the surface physical properties, especially, the slipping properties of the overprint varnish layer.

As a result, they have discovered that a packaging material exhibits excellent performance even at a high-speed packaging machine described above, when the coefficients of dynamic friction and static friction at a surface of the overprint varnish layer are each set in a predetermined range, in a case of measurement under a relatively high load, for example, a load of 3000 g for each area of 63.5 mm×63.5 mm in a friction coefficient test prescribed by “JIS P8147 Friction Coefficient Testing Method of Paper and Paperboard”, resulting in the invention.

Further, the present inventors have also discovered that: when variations in value of dynamic-friction coefficient for a predetermined period of time from an initial stage of measurement of dynamic-friction coefficient, which variations are recorded in a chart in the above-described friction coefficient test, shows a certain pattern, in a friction coefficient test as described above particularly excellent filling properties in a high-speed packaging machine is exhibited; when an angle at which the material slides, prescribed by “JIS P8147 Friction Coefficient Testing Method of Paper and Paperboard”, is set in a predetermined range, more preferable filling properties can be achieved in the high-speed packaging machine; and it is effective to set the content of an extender in an ultraviolet curable overprint varnish composition which forms the overprint varnish layer, at a predetermined amount, for achieving the coefficients of dynamic friction and static friction in such predetermined ranges.

Namely, a first aspect of the present invention is a packaging material which comprising: base material paper; a printed layer formed on the base material paper by an ultraviolet curable ink; and an overprint varnish layer which covers substantially the entire surface of the base material paper with the printed layer formed thereon, wherein a coefficient of dynamic friction on a surface of the overprint varnish layer, which is measured in a friction coefficient test based on JIS P8147 in a state in which the surfaces of the overprint varnish layers overlap and contact with each other under a load of 3000 g for each area of 63.5 mm×63.5 mm, is in a range of 0.300 to 0.600, and a coefficient of static friction measured in the same condition is in a range of 0.600 to 0.900.

In a second aspect of the present invention, when variations in the coefficient of dynamic friction are recorded in a chart, in a state in which the pulling rate of a test sample is set at 100 mm/minute and the moving speed of recording paper is set at 50 mm/minute in the above-described friction coefficient test for the packaging material, a waveform in which the value of the coefficient of dynamic friction decreases as time passes for at least 30 seconds from the initial stage of measurement of dynamic-friction coefficient is obtained.

In a third aspect of the present invention, the angle at which the material slides on the surface of the overprint varnish layer of the packaging material, based on JIS P8147, is in a range of 15 to 20 degrees.

In a fourth aspect of the present invention, the above-described overprint varnish layer is composed of an ultraviolet curable overprint varnish composition which contains 18 to 30% by weight of extender. 19 In a fifth aspect of the present invention, the above-described packaging material is used for packaging a photographic photosensitive material.

### BRIEF DESCRIPTION OF THE DRAWINGS

FIG. 1 is a cross-sectional view which schematically shows a structural example of a packaging material according to the present invention.

FIG. 2A is a chart which shows variations in the coefficient of dynamic friction of a packaging material in an example of the present invention.

FIG. 2B is a chart which shows variations in the coefficient of dynamic friction of a packaging material in a comparative example.

### DETAILED DESCRIPTION OF THE INVENTION

The present invention will be hereinafter described in detail based on a preferred embodiment.

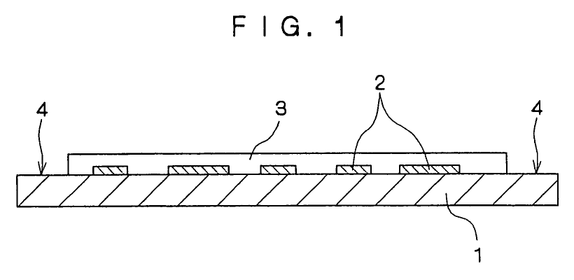

FIG. 1 is a cross-sectional view which schematically shows a structure of a packaging material according to the present invention.

As shown in FIG. 1, the packaging material according to the present invention has, on a base material paper 1, a printed layer 2 of images, characters and the like formed using ultraviolet curable inks having various color tones, and also has, on substantially the entire surface of the base material paper 1 provided with the printed layer 2 (except for a bonding region 4 provided for formation of a carton) or the like, an overprint (OP) varnish layer 3.

The packaging material of the present invention is characterized in that the dynamic-friction coefficient of the OP varnish layer 3 is preferably in a range of 0.300 to 0.600, and more preferably 0.400 to 0.600. The static-friction coefficient of the OP varnish layer 3 is preferably in a range of 0.600 to 0.900, and more preferably 0.600 to 0.850.

These coefficients of dynamic friction and static friction mentioned in the present invention are those obtained by measurement in a friction coefficient test prescribed by “JIS (Japanese Industrial Standard) P8147 friction coefficient testing method for paper and paperboard,” published in 1994, the disclosure of which is incorporated by reference herein, with a load of 3000 g applied to an area of 63.5 mm×63.5 mm.

The friction coefficient test of JIS P8147 used to measure the static and dynamic coefficients of friction will now be briefly described. Further details can be found in the standard itself, published by the Japanese Standards Association and incorporated by reference above. The first technique in the standard is the horizontal plate technique in which a metal, glass, or wooden plate having a flat surface is placed beneath a weight. The weight is a metal block having a smooth surface and is connected by a hook via a pulley mounted on the horizontal plate to a load cell portion of a tensile testing machine.

The material to be tested is mounted to the lower surface of the weight and the upper surface of the horizontal plate. Both ends of the material test piece for the horizontal plate are fixed thereto with adhesive tape so as not to generate any wrinkles or slack. Both ends of the material test piece for the weight are adhered to the front and rear end surfaces of the weight with adhesive tape so as to bring the test piece into close contact with the weight without generating any wrinkles or slack at a sliding surface.

One end of a thin metal wire or synthetic fiber is tied to a hook of the weight, and the other end is attached to the load cell of the tension testing machine. The weight is moved approximately 50 mm, and frictional force is recorded during the movement. An initial peak shown at the moment when the weight begins to move is defined as static frictional force, and frictional force shown while the weight continues to move is defined as dynamic frictional force.

A coefficient of static friction and a coefficient of dynamic friction are calculated according to the following formulae. In the formulae:

μₛ=Fμₛ/Fₙ

μₖ=Fμₖ/Fₙ

μₛ represents the coefficient of static friction;

Fμₛ represents the static frictional force (mN) {gf};

Fₙ represents the vertical load applied by the weight (mN) {gf};

μₖ represents the coefficient of dynamic friction; and

Fμₖ represents an average dynamic frictional force (mN) {gf}.

A second technique measures the angle of inclination of sliding using a main body and a weight. The main body includes an inclining plate which is attached to a fixed base via a hinge and can open far enough for an inclination angle of the inclining plate to [symbol] become attached to is a dial plate which can indicate the inclination angle in units of 0.5°. A clamp for fixing a test piece is mounted at an upper end of the inclining plate, and a stopper is attached to a lower end of the inclining plate. The inclining plate is made from metal, hardwood, glass, or hard plastic, and has a smooth surface.

A weight used in the test is a metal block having a flat, rectangular bottom surface, and having attached thereto clamps for fixing a test piece. Surfaces at which the test piece is mounted (the bottom surface and side surfaces) may be covered with a rubber sheet having a thickness of 3 mm or greater. Levelness is confirmed using the level mounted to the fixed base of the main body. The material test piece for the main body is adhered to the inclining plate of the main body and the material test piece for the weight is adhered to the weight, with respective measuring surfaces thereof facing outward. The inclination angle of the inclining plate is adjusted to zero, and the weight having the test piece mounted thereto is placed on the test piece for the main body. The inclination angle of the inclining plate is increased at a constant speed and an inclination angle when the weight begins to slide is read. The operations are repeated so as to conduct measurement at least five times for one combination.

A tangent (tan θ) of an angle at commencement of sliding is defined as the coefficient of static friction.

If the dynamic-friction coefficient of the OP varnish layer 3 is less than 0.300, the slipping properties of the packaging material surface become too high. In this case, the phenomenon in which a carton jumps out from the carton box-making section of the packaging machine is likely to occur. If the dynamic-friction coefficient is greater than 0.600, the slipping properties are not successfully exhibited between surfaces of the stacked packaging materials when the packaging materials are fed out at a high speed, with a load applied thereto, whereby simultaneous feeding of two cartons in the carton supplying section, or the like may be caused. In short, either case is not preferable.

Further, unless the coefficient of static friction is in the range of 0.600 to 0.900, there is a high possibility that simultaneous feeding of two cartons in the carton supplying section, or the like may occur.

When the coefficients of dynamic friction and static friction are measured under a low, standard load, it is difficult to observe variations which are significant enough for determining whether the packaging performance of a packaging material as in the present invention is good or bad. The characteristic physical properties of the packaging material can be obtained only by measuring frictional coefficients under a high load as described above. This discovery has been made for the first time by the present inventors.

In the packaging material of the present invention, specific factors which cause the surface of the OP varnish layer 3 to exhibit the above-described desired coefficients of dynamic friction and static friction are not particularly restricted. For example, the surface roughness (smoothness) of base material paper, ink receiving property, ink permeability and the like, as the factors, may be adjusted. As will be described later, it is preferable that the amount of an extender contained in the ultraviolet curable OP varnish composition used to form the OP varnish layer 3 is set in a predetermined range.

The extender is generally contained in a conventional ultraviolet curable OP varnish composition by a small amount. By increasing the amount of extender contained in the OP varnish composition to a predetermined range, the surface of the formed OP varnish layer 3 is provided with irregularities of adequate degrees due to the extender blended therein. As a result, it is considered that the contact area between surfaces when the packaging materials are stacked becomes smaller and the desired coefficients of dynamic friction and static friction are exhibited.

Furthermore, unlike a case in which a liquid slipping agent such as silicone oil is used as a lubricant, the above-described extender can provide stable slipping properties without causing variation in the slipping properties, which variation is due to bleed generated as time passes or by variations in temperature conditions.

In the packaging material of the present invention, when variations in the coefficient of dynamic friction are recorded in a chart by setting the pulling rate of a test sample at 100 mm/minute and the travelling speed of recording paper at 50 mm/minute in the above-described friction coefficient test, the values of the coefficient of dynamic friction preferably plot a waveform which decreases as time passes for at least 30 seconds from an initial stage of measurement of the dynamic-friction coefficient.

In a case in which the coefficient value of dynamic friction increases as time passes or plots a waveform of shifting substantially in parallel in the above-described measurement, the packaging materials are not stably fed out, when fed out by a high-speed packaging machine at a high speed. In such cases, for example, even when the coefficients of dynamic friction and static friction are set in the above-described predetermined ranges, there is a possibility that a drawback that simultaneous feeding of two cartons in a carton supplying section may occur.

In addition, in a case in which the slipping properties is provided by adding an extender to the OP varnish layer as described above, it has been confirmed that, in the above-described friction coefficient test under a high load, the value of the coefficient of dynamic friction to be measured is gradually shift to a lower value (in a direction to which resistance becomes smaller) from the initial stage of measurement, that is, the above-described waveform desirable for the purpose of providing an excellent performance of the packaging machine is plotted.

A conventional packaging material using an oil-based ink and oil-based OP varnish is generally slippery as compared with the packaging material using an ultraviolet curable ink and ultraviolet curable OP varnish.

It takes a long time for printed oil-based ink to dry. Therefore, powder such as cornstarch is applied to a printed surface so as to prevent blocking from occurring on a lamination layer immediately after printing, which powder affects the slipping properties of the packaging material printed with oil-based ink. That is, this powder functions just as a roller between contact surfaces of packaging materials. Accordingly, in this case of adding powder in the friction coefficient test under a high load, the coefficient of dynamic friction to be measured plots a characteristic waveform in which the coefficient value gradually shifts to a lower value from the initial stage of the measurement.

As described above, in the packaging material according to the present invention, which provides the slipping properties by adding a predetermined amount of extender into an ultraviolet curable OP varnish composition, a waveform similar to that of the packaging material printed with oil-based ink and having powder added thereto can be obtained. Accordingly, in the present invention, excellent slipping properties similar to those of the packaging material printed with oil-based ink can be achieved in ultraviolet curable printing.

Further, in the packaging material of the present invention, an angle at which the material surface slides, prescribed by JIS P8147, of the OP varnish layer 3 surface is preferably 15 to 20 degrees, so that the high-speed filling performance of packaging material is satisfied. If the angle at which the material surface slides is less than 15 degrees, the slipping properties of the packaging material surface become too high, thereby most likely causing a phenomenon in which cartons jump out from a carton box-making section of a high-speed packaging machine. If the angle at which the material surface slides is greater than 20 degrees, the slipping properties cannot be sufficiently exhibited between the surfaces of stacked packaging materials in a state of being fed out at a high speed with a load applied thereto, and simultaneous feeding of two cartons in the carton supplying section, or the like is likely to occur. Therefore, either case is not preferable.

The type of the base material paper 1 of the packaging material of the present invention is not particularly limited, and can be suitably selected according to purposes or applications of packaging material. For example, various types of thin paper or cardboard, such as acidic paper, neutral paper or alkaline paper (e.g., wood free paper, medium grade paper, one-side glazed paper, and kraft paper, each of which are made from chemical pulp such as hardwood bleached kraft pulp or softwood bleached kraft pulp, or from mechanical pulp such as GP, RGP or TMP using any one of well-known various types of paper machines) can be used. The base material paper suitably contains auxiliary agent for paper production such as paper strength reinforcing agent, sizing agent, filler, yield improver and the like. Further, if necessary, a coating agent such as starch, polyvinyl alcohol or polyacrylonitrile is applied to the base material paper by a size press or a gate roll coater.

When the packaging material according to the present invention is a blank for a carton, cardboard referred to as cardboard with gray back or cardboard with white back, paperboard such as uncoated cardboard, card paper or ivory board, and the like can be used, but are not particularly limited to the same. Further, the basis weight of the packaging material is preferably 230 to 600 g/cm² or thereabouts.

The shape of a carton to which the packaging material of the present invention is applied is not particularly limited. For example, various types of known shapes, that is, sack carton, seal carton, auto bottom, Do lock carton, and the like can be used.

The types of the ultraviolet curable ink used to form, on the surface of the base material paper 1, the printed layer 2 of desired images, characters and the like is not particularly limited. The ultraviolet curable ink may contain, as principal components of the ink, an acrylic prepolymer or oligomer, and a multifunctional acrylate monomer, which serve as a vehicle. Further, the above-described ultraviolet curable ink may contain various pigments as a coloring agent.

As the above-described acrylic prepolymer or oligomer, and multifunctional acrylate monomer, any of known acrylic prepolymers or oligomers, and multifunctional acrylate monomers, which are used as a vehicle of an ultraviolet curable ink or a vehicle of OP varnish, can be used.

Examples of the acrylic prepolymer or oligomer include acrylates such as urethane acrylate, polyester acrylate, epoxy acrylate, polyether acrylate, polyol acrylate and melamine acrylate, and further include methacrylates such as polyester methacrylate, polyether methacrylate, polyol methacrylate and melamine methacrylate.

Examples of the above-described multifunctional acrylate monomer include a bifunctional acrylate monomer such as ethylene glycol diacrylate or 1,6-hexanediol diacrylate, and a tri- or more than tri-functional acrylate monomer such as trimethylolpropane triacrylate, pentaerythritol hexaacrylate, or dipentaerythritol hexaacrylate.

In addition to the above-described compounds, the following acrylates and methacrylates (which will be hereinafter described as (meth)acrylates) can be suitably mixed and used for adjustment of the physical properties of coating and improvement of printability.

Examples of the above-described (meth)acrylates include lauryl (meth)acrylate, stearin (meth)acrylate, methoxydipropylene (meth)acrylate, phenoxypolyethylene glycol (meth)acrylate, polyethylene glycol (meth)acrylate, tripropylene glycol (meth)acrylate, neopentyl glycol di(meth)acrylate, ethoxylated bisphenol A di(meth)acryalate, propoxylated bisphenol A di(meth)acrylate.

The type of the coloring agent contained in the ultraviolet curable ink is not particularly limited. Examples thereof include various types of pigments (including insoluble dyes) such as: a black coloring agent such as carbon black, furnace black or acetylene black alkali blue toner; a yellow coloring agent such as chrome yellow, cadmium yellow, yellow iron oxide, titan yellow, bisazo yellow, naphthol yellow, Hanza yellow, pigment yellow, benzidine yellow, permanent yellow, quinoline yellow lake or anthrapyrimidine yellow; a blue coloring agent such as methylene blue, aniline blue, cobalt blue, cerulean blue, chalco-oil blue, nonmetal phthalocyanine blue, phthalocyanine blue, ultramarine blue, Indanthrene Blue or indigo; a green coloring agent such as chrome green, cobalt green, pigment green B, green gold, phthalocyanine green, malachite green oxalate or polychrome bromcopper phthalocyanine; an orange coloring agent such as permanent orange, molybdenum orange, vulcanized fast orange, benzine orange or Indanthrene Brilliant orange; a brown coloring agent such as iron oxide, invar or permanent brown; a red coloring agent such as red iron oxide, rose iron oxide, antimony powder, permanent red, fire red, brilliant carmine, light-fast red toner, permanent carmine, pyrazolone red, bordeaux, heliobordeaux, rhodamine lake, Dupont oil red, thioindigo red, thioindigo maroon or watching red strontium; and a purple coloring agent such as cobalt purple, fast violet, dioxan violet or methylviolet lake. Extenders described below can also be exemplified. These coloring agents may be used individually, or as a combination of two or more may be used.

The amount of these coloring agents contained in the ultraviolet curable ink used in the present invention is not particularly limited. For example, 15 to 25% by weight of the coloring agents is preferably used.

The ultraviolet curable ink used in the present invention needs to contain a photo-polymerization initiator in addition to the above-described components, and also can contain, if required, a sensitizer, a polymerization inhibitor, waxes and the like.

As the photo-polymerization initiator, any known compound which is appropriate for the purpose can be used. Examples thereof include anthraquinone, benzoin ether, benzophenone, 4,4′-bisdimethylaminobenzophenone, 4,4′-bistrichloromethylbenzophenone, dibutylphenylphosphine, α, α-diethoxyacetophenone, 2-ethyl anthraquinone, benzoin bisphenyl, chlorobenzophenone, benzoin, benzoin methyl ether, benzoin butyl ether, anthraquinone thioxantone, methylorthobenzoyl benzoic acid, and palladimethylaminoacetophenone. However, the present invention is not limited to the same.

As the sensitizer, any known compound which is appropriately for the purpose can be used. Examples thereof include p-dimethyl amion benzoate, triethanol amine, diethanol amine, tri-n-butylphosphine, and hexachlorethane, but the present invention is not limited to the same.

Each of the above-described photo-polymerization initiator and sensitizer can be used as a single compound or as a combination of two or more types of compounds. The contents thereof are preferably in a range of 0.5 to 10% by weight of the total amount of the ink.

Further, examples of the polymerization inhibitor include hydroquinone, hydroquinone monomethyl ether, phenothiazine, N-nitrosophenylhydroxylamine aluminum salt, and the like. The content of the polymerization inhibitor is preferably in a range of 10 ppm to 10% by weight of the total amount of the ink.

As the waxes, for example, low-molecular-weight polyethylene wax or macromolecular wax can be used. The preferable content of the wax is approximately 0 to 5% by weight of the total amount of the ink.

The type of the above-described ultraviolet curable OP varnish composition used to form an OP varnish layer 3 on the surface of the base paper material 1 provided with the printed layer 2 is not particularly limited. The ultraviolet curable OP varnish composition contains, at least as the principal components thereof, an acrylic prepolymer or oligomer, and a multifunctional acrylate monomer similar to those used in the above-described ultraviolet curable ink, which serve as the vehicle.

As the above-described acrylic prepolymer or oligomer, and multifunctional acrylate monomer, any of known acrylic prepolymers, oligomers and multifunctional acrylate monomers can be used in the same way as in the above-described ultraviolet curable ink. As the examples thereof are similar to the above-described compounds, its description will be omitted for the purpose of simplification.

In addition to the above-described acrylic prepolymer or oligomer, and multifunctional acrylate monomer, (meth)acrylate similar to that exemplified in the above-described ultraviolet curable ink can also be appropriately mixed and used in the ultraviolet curable OP varnish composition, for the purposes of adjusting the physical properties of coating and improving printability. As examples of (meth)acrylate mentioned herein include the above-described compounds, its description will be omitted for the purpose of simplification.

The ultraviolet curable OP varnish composition used in the present invention contains a predetermined amount of extender so as to allow a packaging material to have desired surface characteristics, as described above. Examples of the extender include known extender such as calcium carbonate, magnesium carbonate, precipitated barium sulfate, talc, silica powder and the like. These materials can be used as a single compound or a combination of two or more types of compounds.

Among these materials, calcium carbonate is particularly preferably used since it is inexpensive and has various types of particle shapes, which are stable, that is, a cubic shape (colloidal calcium carbonate), powdery bell shape, columnar shape, and spherical shape (light calcium carbonate), an irregular shape (heavy calcium carbonate), and other shapes such as acicular powder or a flake, and the like.

In the present invention, the particle shape of the extender such as calcium carbonate is more preferably an angular shape, for example, a cubic shape, a bell shape or a columnar shape, than a spherical shape.

In the packaging material of the present invention, the content of the above-described extender in the ultraviolet curable OP varnish composition used to form an OP varnish layer is extremely important for the purpose of obtaining a desired coefficient of friction, that is, a dynamic-friction coefficient of 0.300 to 0.600, and a static-friction coefficient of 0.600 to 0.900, when the OP varnish layer is measured in a friction coefficient test based on JIS P8147 in a state in which printed surfaces are made to contact each other, with a load of 3000 g for each area of 63.5 mm×63.5 mm applied thereto.

Specifically, the content of the extender in the ultraviolet curable OP varnish composition is preferably in a range of 18 to 30% by weight of the total amount of the OP varnish composition.

If the content of the above-described extender is less than 18% by weight, it is difficult to achieve the above-described desired coefficient of friction only by the extender contained in the OP varnish layer. For example, there is the possibility that the performance of packaging machine when a high-speed packaging machine is used may not be improved.

If the content of the extender is greater than 30% by weight, there is the possibility that the printing property exhibited by the ultraviolet curable OP varnish composition in planographic printing may be deteriorated.

Further, the average particle size of the extender is preferably in a range of 0.1 to 5 μm. If the average particle size of the extender is less than 0.1 μm, there is the possibility that the above-described desired surface characteristics cannot be obtained even if a desired type of extender is added to the OP varnish layer. If the average particle size is greater than 5 μm, there is the possibility that the printability of planographic printing may be deteriorated when the OP varnish layer is formed.

The ultraviolet curable OP varnish composition used in the present invention needs to contain a photo-polymerization initiator, in addition to the above-described components, and may also contain, if required, a sensitizer, a polymerization inhibitor, waxes and the like.

As the photo-polymerization initiator, any known photo-polymerization initiator which is appropriate for the purpose can be used. Examples thereof are similar to those exemplified in the above-described ultraviolet curable ink, and its description will be omitted for the purpose of simplification.

Further, as the sensitizer, any known sensitizer which is appropriate for the purpose can be used. Examples thereof are similar to those exemplified in the above-described ultraviolet curable ink, and its description will be omitted for the purpose of simplification.

Each of the above-described photo-polymerization initiator and sensitizer can be used as a single compound or as a combination of two or more types of compounds. The contents of the photo-polymerization initiator and the sensitizer are each preferably in a range of 0.5 to 10% by weight of the total amount of the OP varnish composition.

Examples of the polymerization inhibitor are similar to those exemplified in the above-described ultraviolet curable ink, and its description will be omitted for the purpose of simplification. The content thereof is preferably in a range of 10 ppm to 10% by weight of the total amount of the OP varnish composition.

As the above-described waxes, for example, low-molecular-weight polyethylene wax, macromolecular wax and the like can be used. The content of the waxes is preferably in a range of 0 to 3% by weight of the total amount of the ink. If the content of waxes added is extremely large, there is the possibility that the slipping properties of the resulting OP varnish layer may significantly vary as time passes or the temperature changes. This is not preferable.

Next, a method for producing a packaging material according to the present invention will be described briefly.

The packaging material of the present invention can be produced, for example, by printing, on a sheet-like base material, a printed layer of images, characters and the like with an ultraviolet curable ink by using an offset printer equipped with an ultraviolet irradiation device, and thereafter, by providing, by printing, an ultraviolet curable OP varnish composition on the printed base material in line therewith.

A plate which is used for printing of the ultraviolet curable ink and ultraviolet curable OP varnish composition may be a PS plate which employs a dampening solution, or may be a dry offset plate which employs a photosensitive resin plate. The thickness of the OP varnish layer does not need to be so large. However, when it is desired that the OP varnish layer needs to be somewhat thicker, a dry offset plate is preferably used.

Usually, the thickness of the OP varnish layer is appropriately set such that the coating amount is in a range of 1.0 to 5.0 g/m², and the thickness of the printed layer is appropriately set such that the coating amount is in a range of 1.0 to 3.0 g/m².

As a light source of the ultraviolet irradiation device mounted at the offset printer, a high-pressure mercury lamp, a xenon lamp, a metal halide lamp or the like can be used. For example, when a high-pressure mercury lamp is used, lamps whose light quantity is 80 to 160 W/cm are collectively installed by a number required in accordance with a printing speed, for each printing unit or in a paper discharging section, so that the printed ultraviolet curable ink and/or ultraviolet curable OP varnish composition is hardened thereby.

In a case in which a paper carton is manufactured using the packaging material thus produced and packaging is carried out using the paper carton, for example, a sheet-like packaging material with a printed layer and an OP varnish layer printed thereon is punched out into a predetermined shape by a sheet-fed punching machine, to thereby produce a carton blank. Subsequently, sack sticking or the like is carried out by a box manufacturing machine or the like, and a box is thereby produced. Then, for example, sack-stuck blanks are filled, as a folded stack, in a carton supplying section of the packaging machine, and the sack-stuck blanks are sequentially pulled out by suction from the lower side, and thereafter, each blank is made into a rectangular shape by tapping to push two folded sides of the blank. A commercial product is accommodated within a barrel portion of a rectangular a shaped box, and thereafter, both open sides are closed, thereby completing packaging.

As described above, the packaging material according to the present invention is produced by setting the content of extender at 18 to 30% by weight, of the amount of the ultraviolet curable OP varnish composition to form an OP varnish layer, which content is significantly larger than that of the conventional packaging material, so as to have surface characteristics in which the dynamic-friction coefficient of the surface (of the OP varnish layer) is 0.300 to 0.600 and the static-friction coefficient is 0.600 to 0.900, and the coefficient of dynamic friction measured by the friction coefficient test varies, when plotted, in a characteristic waveform which gradually shifts to a lower value from the initial stage of measurement.

As a result, not to mention a packaging machine having a normal speed, a high-speed packaging machine having a printing speed of 500 to 800 cartons/minute also can be favorably used without causing simultaneous feeding of two cartons in a carton supplying section, a phenomenon in which a carton jumped out from a carton box-making section, thereby producing a carton with an excellent performance of packaging machine.

The application of the packaging material according to the present invention is not particularly limited, and the packaging material of the present invention can be used for packaging various types of commercial products. A suitable example of packaging is, for example, packaging of photographic photosensitive material.

### EXAMPLES

The present invention will be further described in detail based on the following examples.

Note that the present invention is not limited to these examples.

### Example 1

On a coat paper (manufactured by Qji Paper Co., Ltd.; “UF” coat cardboard with gray back) having a basis weight of 270 g/cm², serving as base paper material, a printed layer of images was printed using an offset printer equipped with an ultraviolet irradiation device, with ultraviolet curable inks of four colors, that is, green, red, yellow and black (UV carton series, manufactured by The Ink Tech Co.) so that each coating amount after being hardened was about 2 g/m². Subsequently, the ultraviolet curable OP varnish composition having the following composition was solid-printed on the above-described printed layer so that the coating amount after being hardened was about 2 g/m², whereby a packaging material for a carton was prepared.

Ultraviolet curable OP varnish composition:

| | |
|---|---|
| (1) acrylic prepolymer, oligomer | 45 wt. % |
| (2) multifunctional acrylate monomer | 15 wt. % |
| (3) photopolymerization initiator | 8 wt. % |
| (4) extender | 25 wt. % |
| (5) wax | 2 wt. % |
| (6) other additives | 5 wt. % |

The friction coefficients of the surface of the packaging material thus prepared were measured based on the friction coefficient test prescribed by “JIS P8147 Friction Coefficient Testing Method for Paper and Cardboard” with a load of 3000 g for each area of 63.5 mm×63.5 mm applied thereto. Further, the angle at which the material surface slid was measured based on a method for measuring an angle at which a material surface slides, which is provided by “JIS P8147 Friction Coefficient Testing Method for Paper and Cardboard”. The obtained results are shown in Table 1 below.

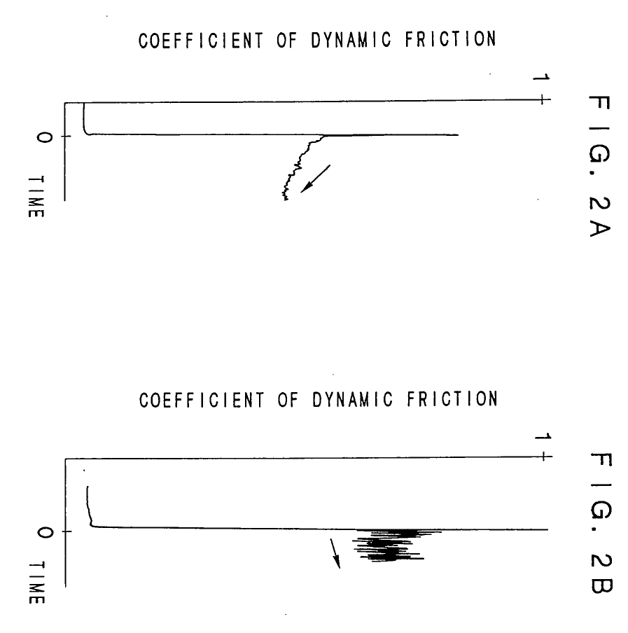

Further, with a pulling rate of a test sample being set at 100 mm/minute and with a moving speed of recording paper being set at 50 mm/minute in the above-described friction coefficient test, variations in the values of the coefficient of dynamic friction for a predetermined period of time, from the initial stage of measurement of the coefficient of dynamic friction, were recorded in a chart. The obtained results are shown in FIG. 2A.

Subsequently, the packaging material thus prepared was punched out by a punch die of a seal-carton type and a blank plate was made into a cylindrical shape using a box manufacturing machine, whereby a seal carton in a folded state was produced.

In order to examine the performance of the thus produced seal carton at the packaging machine, the produced seal cartons were charged in a carton supplying section of a high-speed packaging machine, and a test was carried out in which the operating speed at the time of packaging was increased to 650 cartons/minute. The obtained results are shown in Table 1 below.

### Comparative Example 1

A packaging material was prepared in the same manner as in Example 1 except that an ultraviolet curable OP varnish composition to be used was replaced with a composition described below. The friction coefficient test and measurement of an angle at which the material surface slides were carried out, and the performance of the packaging material at a packaging machine was examined, respectively, in a manner similar to that in Example 1. The obtained results are shown in Table 1 below. Further, variations in the values of the coefficient of dynamic friction were recorded in a chart, as in Example 1. The obtained results are shown in FIG. 2B.

Ultraviolet curable OP varnish composition:

| | |
|---|---|
| (1) acrylic prepolymer, oligomer | 50 wt. % |
| (2) multifunctional acrylate monomer | 33 wt. % |
| (3) photopolymerization initiator | 5 wt. % |
| (4) extender | 7 wt. % |
| (5) wax | 2 wt. % |
| (6) other additives | 3 wt. % |

TABLE 1

| | | | Angle at | |
|---|---|---|---|---|
| | | | which | |
| | Coefficient | Coefficient | material | Performance at |
| | of dynamic | of static | surface | packaging |
| | friction | friction | slid | machine |
| Example 1 | 0.483 | 0.768 | 18.7 | Excellent |
| Comparative | 0.685 | >1.0 | 30.5 | A phenomenon |
| Example 1 | | | | occurred in which |
| | | | | two cartons were |
| | | | | simultaneously |
| | | | | fed out in a |
| | | | | carton supplying |
| | | | | section |

As shown in Table 1, in the packaging material of Example 1 according to the present invention, the numerical value of the coefficient of dynamic friction was 0.483, that is, a relatively low value, and the coefficient of static friction was 0.768, which is an appropriate value, and the angle at which the material surface slid was a value lower than 20 degrees.

Further, as shown in FIG. 2A, when variations in the value of the coefficient of dynamic friction were recorded in a chart, the measured values of the coefficient of dynamic friction, when plotted, showed a waveform which decreases as time passes for at least 30 seconds from the initial stage of measurement of the coefficient of dynamic friction. Accordingly, from the measurement data, it was confirmed that the desired surface characteristics were obtained. The performance of the material at the packaging machine was also excellent without causing either simultaneous feeding of two cartons in a carton supplying section or a phenomenon in which a carton jumps out from a carton box-making section.

On the contrary, in comparative example 1, the numerical value of the dynamic-friction coefficient was relatively high, which is, 0.685, and the coefficient of static friction was a very large value which exceeds 1.0. As shown in FIG. 2B, when variations in the value of the coefficient of dynamic friction was recorded in a chart, the coefficient value of dynamic friction varied significantly in an unstable manner and the measured values, when plotted, showed a waveform which increases as time passes. As a result, in the characteristic test of a packaging machine, a phenomenon in which two cartons were fed out simultaneously in the carton supplying section occurred.

### Example 2

A packaging material was prepared in the same manner as in Example 1 except that an ultraviolet curable OP varnish composition was replaced with a composition as described below. The friction coefficient test, measurement of the angle at which the material surface slid, and observation of chart variations in the value of the coefficient of dynamic friction were carried out, and the performance of the material at the packaging machine was examined, respectively, as in Example 1.

Ultraviolet curable OP varnish composition:

| | |
|---|---|
| (1) acrylic prepolymer, oligomer | 44 wt. % |
| (2) multifunctional acrylate monomer | 20 wt. % |
| (3) photopolymerization initiator | 8 wt. % |
| (4) extender | 20 wt. % |
| (5) wax | 3 wt. % |
| (6) other additives | 5 wt. % |

As a result, in the packaging material of Example 2, substantially the same value as that of Example 1 was obtained for each of the coefficient of dynamic friction, coefficient of static friction, and angle at which the material surface slides. Further, the chart variations in the coefficient of dynamic friction showed a waveform in which the value of coefficient of dynamic friction decreased as time passes for at least 30 seconds from the initial stage of measurement of the coefficient of dynamic friction, in the same manner as in FIG. 2A. Moreover, the performance of the material at the packaging machine was also excellent since neither simultaneous feeding of two cartons in the carton supplying section nor a phenomenon in which a carton jumps out from the carton box-making section occurred.

### Example 3

A packaging material was prepared in the same manner as in Example 1 except that an ultraviolet curable OP varnish composition was replaced with a composition described below. The friction coefficient test, measurement of the angle at which the material surface slides, and observation of chart variations in the value of coefficient of dynamic friction were carried out, and the performance of the material at the packaging machine was examined, respectively, as in Example 1.

Ultraviolet curable OP varnish composition:

| | |
|---|---|
| (1) acrylic prepolymer, oligomer | 41 wt. % |
| (2) multifunctional acrylate monomer | 15 wt. % |
| (3) photopolymerization initiator | 8 wt. % |
| (4) extender | 30 wt. % |
| (5) wax | 1 wt. % |
| (6) other additives | 5 wt. % |

As a result, in the packaging material of Example 3, substantially the same value as that of Example 1 was obtained for each of the coefficient of dynamic friction, coefficient value of static friction, and angle at which the material slid. Further, the chart variations in the value of coefficient of dynamic friction showed a waveform in which the coefficient value of dynamic friction decreased as time passes for at least 30 seconds from the initial stage of measurement of the coefficient of dynamic friction, in the same manner as in FIG. 2A. Moreover, the performance of the material at the packaging machine was also excellent since simultaneous feeding of two cartons in the carton supplying section, and a phenomenon in which a carton jumps out in the carton box-making section did not occur.

### Example 4

The packaging materials prepared by Examples 1 to 3 were used for producing packaging boxes used for films, SUPER IA100, produced by FUJI PHOTO FILM CO., LTD. Each of the boxes exhibited the desired effects of the present invention and good performance of storing a photosensitive material.

As described above, the present invention can provide a packaging material such as a carton with excellent wear resistance and scratching resistance required, and also can provide a packaging material exhibiting excellent surface characteristics and excellent performance at a packaging machine, in which in a case of using the packaging material as a folded carton, even when folded cartons are fed out at a high speed by a high-speed packaging machine (500 to 800 cartons/minute), not to mention an ordinary packaging machine (100 to 200 cartons/minute) under a load of 3 to 5 kg applied to each carton in a carton supplying section, neither a problem in that two cartons are fed out simultaneously, nor a phenomenon in which a carton jumps out from a carton box-making section occurs.

What is claimed is:

1. A packaging material comprising:
base material paper;
a printed layer formed on said base material paper by an ultraviolet curable ink; and
an overprint varnish layer which covers substantially the entire surface of the base material paper with said printed layer formed thereon,
wherein a coefficient of dynamic friction on a surface of the overprint varnish layer, which is measured in a friction coefficient test in a state in which the surfaces of the overprint varnish layers overlap and contact with each other under a load of 3000 g for each area of 63.5 mm×63.5 mm, is in a range of 0.300 to 0.600, and a coefficient of static friction measured in the same condition is in a range of 0.600 to 0.900.

2. The packaging material according to claim 1, wherein when variations in the coefficient of dynamic friction are recorded in a chart by setting the pulling rate of a test portion at 100 mm/minute and the moving speed of recording paper at 50 mm/minute in said friction coefficient test, the value of the coefficient of dynamic friction, when plotted, shows a waveform which decreases as time passes for at least 30 seconds from an initial stage of measurement of dynamic-friction coefficient.

3. The packaging material according to claim 1, wherein an angle at which the surface of said overprint varnish layer slides is in a range of 15 to 20 degrees.

4. The packaging material according to claim 1, wherein said overprint varnish layer is composed of an ultraviolet curable overprint varnish composition, which composition contains 18 to 30% by weight of extender.

5. The packaging material according to claim 4, wherein said extender is at least one type of extender selected from a group consisting of calcium carbonate, magnesium carbonate, precipitated barium sulfate, talc and silica.

6. The packaging material according to claim 4, wherein the particle shape of said extender is angular.

7. The packaging material according to claim 4, wherein the average particle size of said extender is in a range of 0.1 to 5 μm.

8. A packaging material comprising:
base material paper;
a printed layer formed on said base material paper by an ultraviolet curable ink; and
an overprint varnish layer which covers substantially the entire surface of the base material paper provided with said printed layer,
wherein said overprint varnish layer is composed of an ultraviolet curable overprint varnish composition, which composition contains 18 to 30% by weight of extender.

9. The packaging material according to claim 8, wherein said ultraviolet curable overprint varnish composition contains, as principal components, an acrylic prepolymer or oligomer, and a multifunctional acrylate monomer, which serve as a vehicle.

10. The packaging material according to claim 8, wherein said extender is at least one type of extender selected from a group consisting of calcium carbonate, magnesium carbonate, precipitated barium sulfate, talc and silica.

11. The packaging material according to claim 8, wherein the particle shape of said extender is angular.

12. The packaging material according to claim 8, wherein the average particle size of said extender is in a range of 0.1 to 5 μm.

13. The packaging material according to claim 8, wherein a coefficient of dynamic friction on a surface of the overprint varnish layer, which is measured in a friction coefficient test in a state in which the surfaces of the overprint varnish layers overlap and contact with each other under a load of 3000 g for each area of 63.5 mm×63.5 mm, is in a range of 0.300 to 0.600, and a coefficient of static friction measured in the same condition is in a range of 0.600 to 0.900.

14. The packaging material according to claim 8, wherein when variations in the coefficient of dynamic friction are recorded in a chart by setting the pulling rate of a test portion at 100 mm/minute and the moving speed of recording paper at 50 mm/minute in said friction coefficient test, the value of the coefficient of dynamic friction, when plotted, shows a waveform which decreases as time passes for at least 30 seconds from an initial stage of measurement of dynamic-friction coefficient.

15. The packaging material according to claim 8, wherein an angle at which the surface of said overprint varnish layer slides is in a range of 15 to 20 degrees.

16. A packaging material comprising:
base material paper;
a printed layer formed on said base material paper by an ultraviolet curable ink; and
an overprint varnish layer which covers substantially the entire surface of the base material paper provided with said printed layer,
wherein when variations in the coefficient of dynamic friction are recorded in a chart by setting the pulling rate of a test portion at 100 mm/minute and the moving speed of recording paper at 50 mm/minute, in a friction coefficient test in a state in which the surfaces of the overprint varnish layers overlap and contact with each other, the value of the coefficient of dynamic friction, when plotted, shows a waveform which decreases as time passes for at least 30 seconds from an initial stage of measurement of dynamic-friction coefficient.

17. The packaging material according to claim 16, wherein a coefficient of dynamic friction on the surface of the overprint varnish layer, which is measured in said friction coefficient test under a load of 3000 g for each area of 63.5 mm×63.5 mm, is in a range of 0.300 to 0.600, and a coefficient of static friction measured in the same condition is in a range of 0.600 to 0.900.

18. The packaging material according to claim 16, wherein an angle at which the surface of said overprint varnish layer slides is in a range of 15 to 20 degrees.

19. The packaging material according to claim 16, wherein said overprint varnish layer is composed of an ultraviolet curable overprint varnish composition, which composition contains 18 to 30% by weight of extender.

20. The packaging material according to claim 1, wherein said packaging material is used for packaging a photographic photosensitive material.
